(19) United States
(12) Patent Application Publication
(10) Pub. No.: US 2025/0040516 A1
(43) Pub. Date: Feb. 6, 2025

(54) ClipUp pet accessories - Pet harness collar and leash decorative CLIPUP

(71) Applicant: Marina Eskenazi, Miami, FL (US)

(72) Inventor: Marina Eskenazi, Miami, FL (US)

(21) Appl. No.: 18/416,378

(22) Filed: Jan. 18, 2024

Related U.S. Application Data
(60) Provisional application No. 63/481,169, filed on Jan. 23, 2023.

(51) Int. Cl. A01K 27/00

(52) U.S. Cl. CPC A01K 27/006; A01K 27/002

(57) ABSTRACT

A pet harness featuring multiple perforations along its body for the attachment of decorative accessories. The system includes decorative charms equipped with a ClipUp backing mechanism, allowing for secure and interchangeable attachment to the harness. This enables customization of the harness by inserting or removing the charms through the perforations without compromising the structural integrity or comfort of the harness.

The present invention relates to a customizable pet accessories: harness, collar, and leash that includes a plurality of perforations, allowing for the secure and interchangeable attachment of decorative charms. The perforations are strategically placed to maintain both the structural integrity and the comfort of the Pet Harness, Collar, Leash, ensuring that the attachment of charms does not interfere with the pet's movement. The ClipUp backing mechanism provides a secure yet easily operable means for the user to change the decorative appearance of the pet harness, collar, or leash as desired, offering a personalized and stylish look for their pet.

### DETAILED DESCRIPTION OF THE INVENTION

The “Dog Accessories: Harness, Collar, and Leash Decorative,” or “ClipUp,” are designed with multiple perforations strategically placed along the body of the harness, collar, and leash. These perforations are intended to facilitate the easy attachment and removal of decorative charms, offering unlimited customization options for pet accessories.

The system allows users to personalize the appearance of their pet's harness, collar, and leash by clipping interchangeable charms into the pre-formed holes. These charms, which may include additional features such as LED lights, provide aesthetic enhancements and functional elements, allowing the pet accessories to be both practical and visually appealing.

### Version of the Invention

The discussed version of the invention includes clip-on charms (referred to as “ClipUp charms”), which can be inserted into the holes along the harness, collar, or leash. These charms can come in various designs, materials, and styles, including decorative elements that illuminate, adding a unique visual feature to the pet accessories.

### Problem Solved

This invention addresses the need for pet accessories that combine functionality and style. While traditional pet harnesses, collars, and leashes primarily serve to secure and guide pets, this invention introduces a customizable solution that allows users to express personal style by adding and replacing decorative charms. The ClipUp system enables this while maintaining the integrity and comfort of the pet accessory.

### Use of the Invention

The “Dog Accessories: Harness, Collar, and Leash Decorative” system offers a novel approach to pet accessories, turning them into customizable fashion items. Users can purchase charms from a wide range of available styles and easily attach them to the perforations on the harness, collar, or leash. This system adds an element of personalization, making it suitable for everyday use or special occasions.

### How to Make the Invention

The harness, collar, and leash are manufactured with strategically placed holes of approximately 8 mm in diameter. The number of holes varies depending on the size of the accessory, with larger sizes accommodating more charms. For example, an XXL harness may include up to six or more perforations along each strap or band, allowing users to attach multiple charms. The materials used for the harness, collar, and leash are selected for durability, ensuring that the accessories remain functional and comfortable during use, while still allowing for the secure attachment of charms.

### Materials List

Dog Harness, Collar, and Leash.
Clip decorative charms with backs to Clip in holes of different styles and materials

### Conclusion

The “Dog Harness, Collar, and Leash Decorative” presents an innovative solution to enhance the functionality of pet accessories by incorporating decorative elements. The ability to customize the harness, collar, and leash with clip charms allows users to express their style and add a touch of fashion to their pets.

I request that this provisional patent application be examined for compliance with patentability requirements. Please find the accompanying drawings and other relevant documents.

Thank you for your attention to this matter.

### Description

The present invention relates to a customizable pet Pet Harness, Collar, Leash that includes a plurality of perforations, allowing for the secure and interchangeable attachment of decorative charms. The perforations are strategically placed to maintain both the structural integrity and the comfort of the Pet Harness, Collar, Leash, ensuring that the attachment of charms does not interfere with the pet's movement The ClipUp backing mechanism provides a secure yet easily operable means for the user to change the decorative appearance of the Pet Harness, Collar, Leash as desired, offering a personalized and stylish look for their pet

### BRIEF DESCRIPTION OF THE DRAWINGS

FIG. 1: Illustrates a pet harness with multiple holes strategically placed along the body of the accessory. These holes are designed for the insertion of decorative charms with backstop Clip into the harness, collar, and leash holes, allowing for interchangeable customization of the pet harness.

FIG. 2: Shows three different design examples of decorative charms, each equipped with a back clip mechanism. These charms are depicted being inserted into pre-formed holes on a decorative pet accessory, demonstrating the interchangeability of the charm designs on the pet harness, collar, and leash.

FIG. 3: Depicts a pet collar and leash with pre-formed holes, showcasing how the ClipUp system allows decorative charms to be inserted into the holes on both accessories. It also highlights the versatility of the design by displaying the insertion of charms on both the collar and the leash.

FIG. 4: Demonstrates a pet leash with pre-formed holes designed to accommodate interchangeable decorative charms. The figure highlights how the ClipUp system works on the leash, allowing users to insert and remove charms easily, providing a customizable experience for the pet accessory.

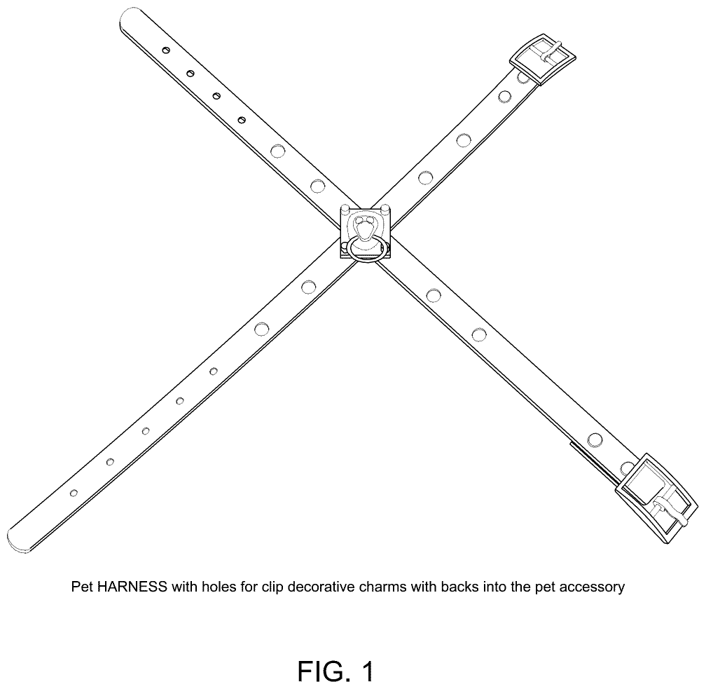

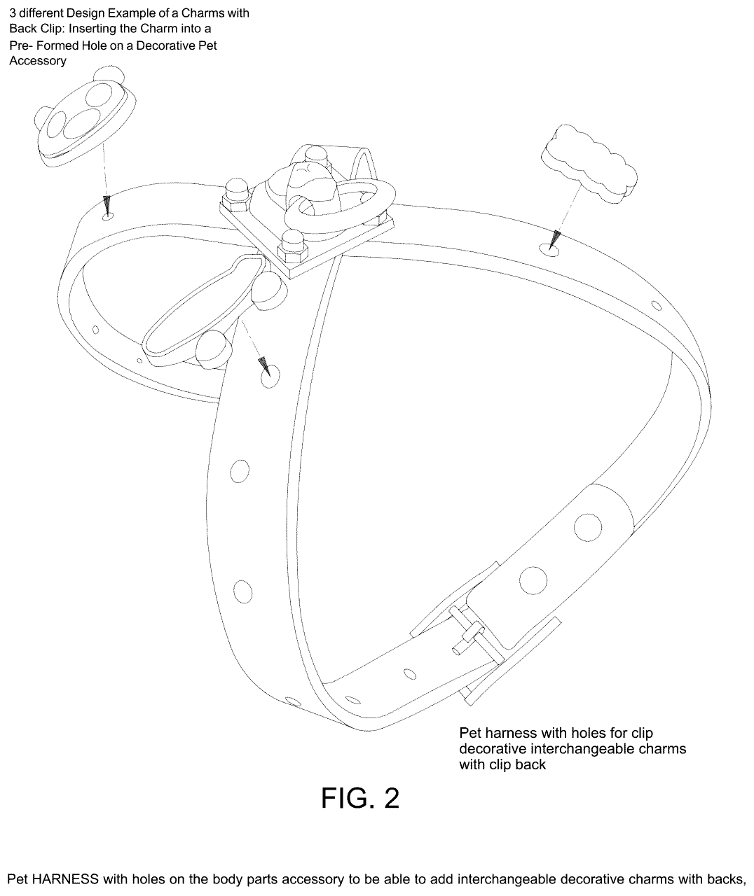

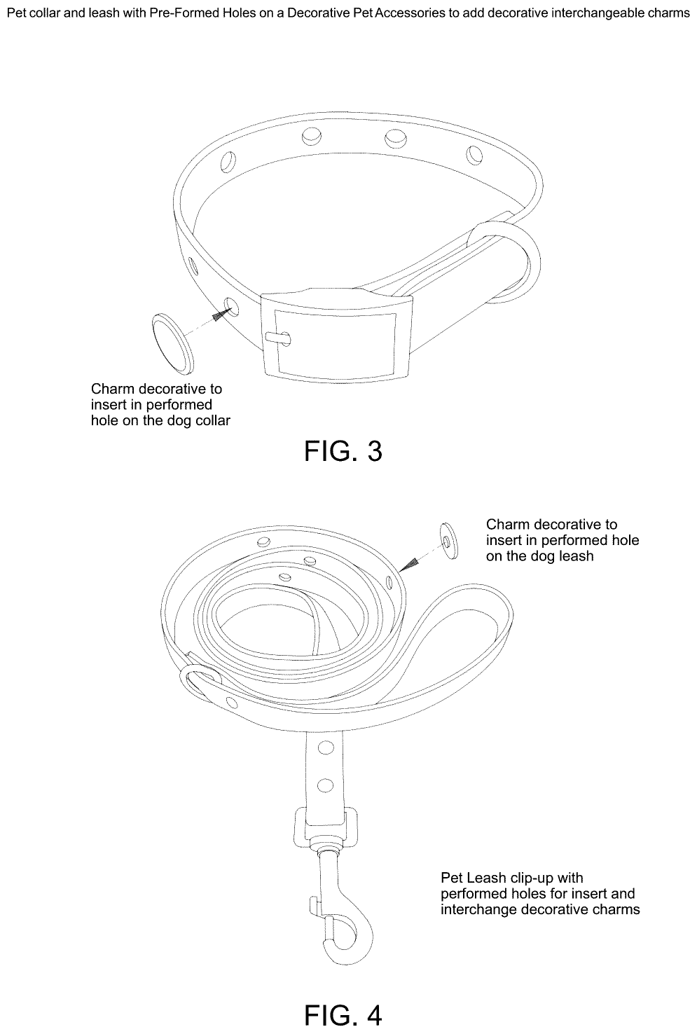

1. A Pet Harness, Collar, Leash, comprising:
a. A body portion with multiple perforations distributed along the accessory's (Pet Harness, Collar, Leash) structure;
b. A set of decorative charms, each equipped with a ClipUp backing mechanism designed to insert and lock into the perforations on the Pet Harness, Collar, Leash body;
c. The ClipUp backing mechanism featuring a locking design that secures the charm in place while allowing for easy removal and replacement by the user.
The Pet Harness, Collar, Leash of claim 1, wherein the perforations are distributed in a predetermined pattern to optimize both aesthetic design and structural integrity without compromising the harness's durability or flexibility.
The Pet Harness, Collar, Leash of claim 1, further comprising:
a. A resilient material construction for the harness body that allows for flexibility during movement while maintaining the position of the attached decorative charms.
The ClipUp backing mechanism of claim 1, wherein the backing comprises:
a. A spring-loaded clip or snap-on system that allows for repeated attachment and detachment without wear on the perforations or the charms;
b. A durable material resistant to corrosion, ensuring long-term usability in various environmental conditions.
The Pet Harness, Collar, Leash of claim 1, wherein the charms can be attached, detached, or rearranged without the need for additional tools, allowing for user-friendly customization.
